(19) United States
(12) Patent Application Publication
(10) Pub. No.: US 2008/0320203 A1
(43) Pub. Date: Dec. 25, 2008

(54) Memory Management in a Computing Device

(75) Inventor: Richard Fitzgerald, Surrey (GB)

Correspondence Address: FOX ROTHSCHILD LLP, P O BOX 592, 112 NASSAU STREET, PRINCETON, NJ, 08542-0592, US

(73) Assignee: SYMBIAN SOFTWARE LIMITED, London (GB)

(21) Appl. No.: 11/914,626

(22) PCT Filed: May 17, 2006
(86) PCT No.: PCT/GB06/01814

§ 371 Date: Jun. 30, 2008

(30) Foreign Application Priority Data
May 18, 2005 (GB) 0510188.6

(51) Int. Cl. G06F 12/06

(52) U.S. Cl. 711/5; 711/E12.082

(57) ABSTRACT

A computing device incorporating memory such as mobile SDRAM, which is capable of conserving energy by being operated in a low-power self-refresh mode, is enabled to identify those regions of memory which are allocated but inactive. These regions are collected into specific banks of memory so as to create banks of memory containing only inactive data and which can then be placed in self-refresh. This reduces the power consumed by the computing device, and improves the energy efficiency of the device.

This invention discloses a method of improving the energy consumption of a computing device, and in particular to improving the energy consumption of a computing device by reducing the power consumed by the Random Access Memory (RAM) of the device.

The term computing device as used herein is to be expansively construed to cover any form of electrical computing device and includes data recording devices, computers of any type or form, including hand held and personal computers such as Personal Digital Assistants (PDAs), and communication devices of any form factor, including mobile phones, smart phones, communicators which combine communications, image recording and/or playback, and computing functionality within a single device, and other forms of wireless and wired information devices, including digital cameras, MP3 and other music players, and digital radios.

Minimising the amount of power consumed by computing devices when in use is important for a number of reasons. For one class of devices, namely battery-operated mobile computing devices such as mobile telephones, music players or portable games consoles, the length of time that the device can operate without the batteries needing to be recharged or replaced is known to be a key factor in decisions as to which type of device is purchased, and subsequently has a major impact on patterns of everyday use. Minimising the amount of power such devices consume is clearly one of the key technologies in this area. However, for all devices, even those which run on mains power and aren't constrained by the same scarce power resources that affect mobile battery operated devices, minimising power consumption is the key metric for energy efficiency which is recognised as being an essential part of global efforts to protect the environment.

It is known that the design of software components used in computing devices can have a major affect on device power consumption. The US Government Energy Star programme (http://www.energystar.gov) encourages the manufacturers of devices such as printers, disk drives and monitors to design their products in such a way that they can detect periods of inactivity and respond to them by moving to a relatively low-power mode, and many desktop computers include power management configuration in their operating systems.

One example of the way that improvements in operating system design can minimise power consumption in mobile computing devices is in the area of memory management.

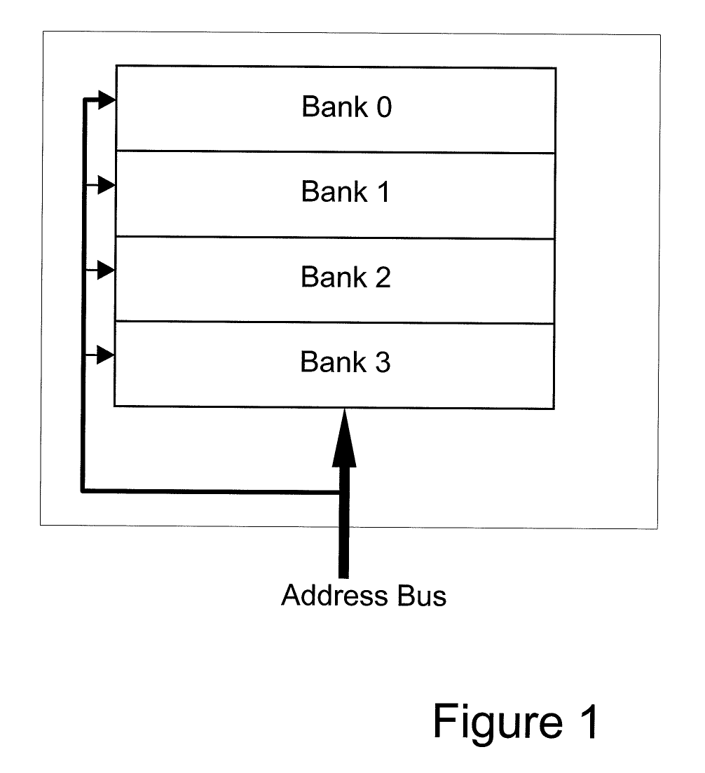

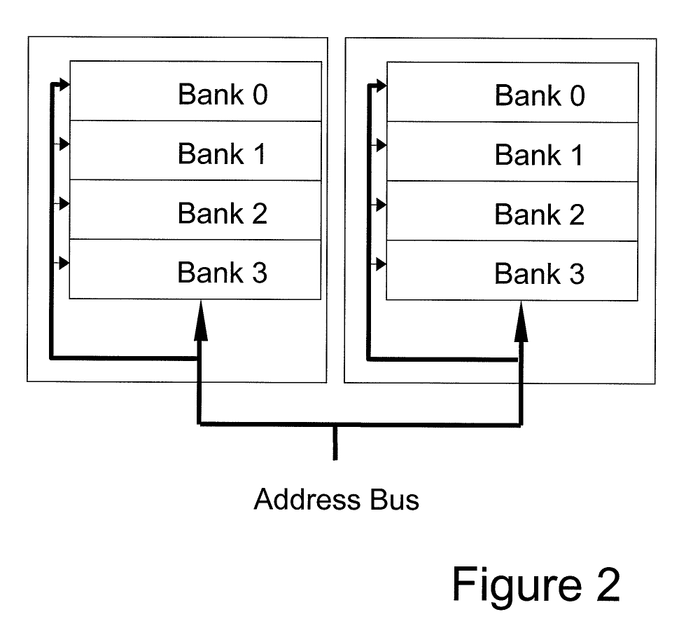

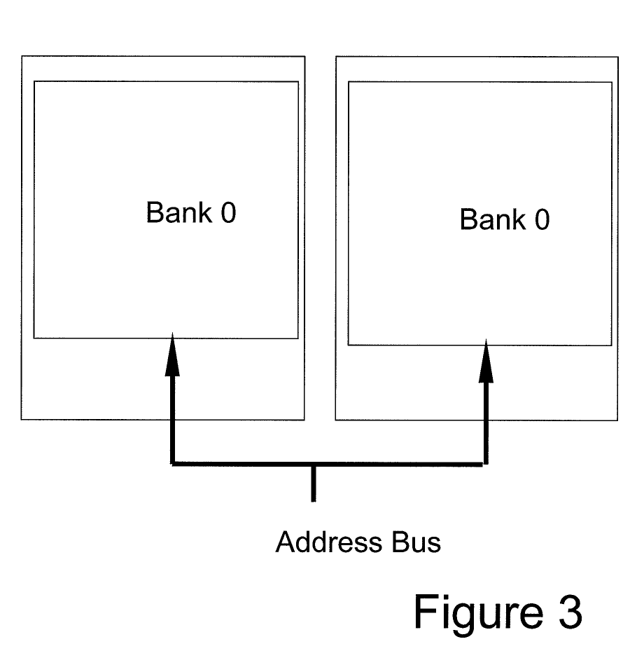

For example, memory on computing devices is typically arranged in banks, with an address or data bus for passing data to each bank from, for example, the central processing unit (CPU) of the device. An example of this type of memory is shown schematically in FIG. 1. In essence, each bank is arranged in parallel with respect to the data bus, with the size of each bank dictated by the width of the data bus used by the central processing unit (CPU) of the device. Thus, a CPU with a 32 bit data bus will have memory arranged in banks which are 32 bits wide. There is also a variety of ways in which the RAM in a device can be configured. For example, the memory may be arranged with multiple banks per device, as shown in FIG. 2. Alternatively, the memory in the device can be configured using RAM devices which do not contain multiple banks, but in which each RAM device per se can be put individually into self refresh, as shown in FIG. 3. The number of RAM devices actually used to provide the device dynamic memory is also the choice of the system designer, and usually depends in some way to device functionality.

That an operating system can make use of this way of arranging memory in order to minimise power consumption and make computing devices more energy efficient is disclosed in GB2406668A entitled “Memory Management in a Computing Device”. This document describes how a computing device can rearrange the physical Random Access Memory (RAM) it is using so as to occupy the smallest number of contiguous blocks, thereby creating unused memory banks which can be completely powered down and switched off.

In addition to memory banks being turned either ‘on’ or ‘off’, it is now possible for them to be placed in a third state, where they are still in a powered mode but nevertheless consume significantly smaller amounts of power in comparison to the fully ‘on’ mode.

This low-power mode is sometimes known as standby mode but is more accurately termed the self-refresh mode. It is a notable feature of modern types of memory such as Mobile SDRAM (Synchronous Dynamic RAM). Self-refresh has been described as “a memory technology that enables DRAM to refresh on its own and independent of the CPU or external refresh circuitry. Self-Refresh technology is built into the DRAM chip itself and reduces power consumption dramatically”.

When an entire computing device is placed in standby mode, such as when a laptop goes into hibernation, placing all the memory in self-refresh mode saves considerable amounts of power and prolongs battery life; generally, most internal clocks and buffers in these devices are also disabled and placed in self-refresh mode.

There is a cost to placing memory banks in this ‘low-power’ mode because, when in self-refresh, a memory bank cannot be accessed by the CPU; a memory bank must be taken out of self-refresh mode and placed in full power mode in order to be accessed. This is why self-refresh is generally used only when the entire computing device is on standby.

Current models of active memory management, such as GB2406668A referred to above, assume that there are only two significant states for memory; either ‘on’ or ‘off’ (fully powered up, or fully powered down). Such models take no account of the intermediate state represented by low-power modes such as self-refresh.

It is therefore an object of the present invention to reduce the power consumption of a computing device by making use of this low power mode.

According to a first aspect of the present invention there is provided a method of managing resources in a computing device including memory capable of operating in a reduced functionality low-power mode, the method comprising:
a. identifying blocks of memory which have been allocated but which are not in active use;
b. collecting the contents of the said inactive memory blocks in one or more physical memory banks identified for the collection of inactive data;
c. remapping the locations of the said inactive memory blocks to the said physical memory banks;
d. placing the said physical memory banks in a low-power mode for conserving energy; and wherein
e. subsequent access to any physical memory bank which has been placed in low-power mode causes the device to place the said physical memory bank into normal full-power operational mode.

According to a second aspect of the present invention there is provided a computing device programmed to implement a method according to the first aspect.

According to a third aspect of the present invention there is provided an operating system for causing a computing device to operate in accordance with a method of the first aspect.

An embodiment of the present invention will now be described, by way of further example only, with reference to the accompanying drawings in which:

FIG. 1 shows a memory system using a single RAM device with multiple banks;

FIG. 2 shows a memory system using multiple RAM devices with multiple banks per device;

FIG. 3 shows a memory system using multiple RAM devices that do not contain multiple banks but in which each RAM device can be individually put into a self-refresh mode; and

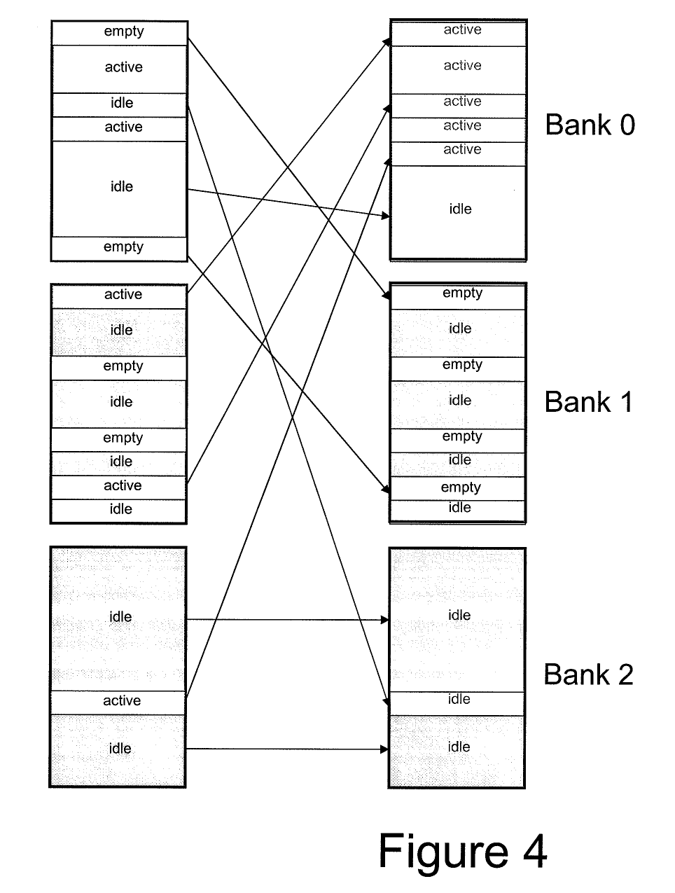

FIG. 4 shows an example of rearranging active and idle memory in a three bank dynamic memory of a computing device, in accordance with the present invention.

The perception behind this invention is that, as part of an active memory management scheme in a computing device, it is possible to exploit the potential to further reduce the power consumption of the device by identifying data that is inactive (not recently used) and collecting such data together in one or more memory banks, which can then be kept in self-refresh low-power mode even when the computing device is otherwise fully operational.

The consequence is that this potentially saves power, since in self-refresh mode the memory bank will consume far less power than it would in the full active state. Because this low power state is only used for memory that has been identified as being inactive, the disadvantage of keeping memory in self-refresh (that it cannot be accessed immediately) does not significantly impact upon the overall performance of the device,

The description below will be readily understandable by those skilled in the art of designing computing devices, to whom concepts such as demand paging, exception handling, memory defragmentation, null thread and memory management units (MMUS) will be familiar. Accordingly, these terms are assumed to be understood and will not be described further in the context of the present invention. Furthermore, although this invention is largely described in terms of self-refresh, this is not intended to limit the scope of this invention, which it is applicable to any other low-power mode which conserves energy at the cost of restricting functionality.

A preliminary step for implementing this invention is to identify allocated memory blocks that are not actively being used. For the purposes of this invention, a memory block can be defined as the unit of memory allocation. Examples of such memory might include:
memory that has been allocated to a background application which has been idle for a relatively long period of time
buffers which are used only occasionally but which are nevertheless permanently allocated because their contents must be preserved
most fonts and bitmaps
device-specific allocated memory; for example, on a mobile telephone, telephony data is normally only used when a phone call is made.
code which is present in RAM, for example loaded from a removable media, downloaded from the internet or an over-the-air service, or as a shadow of code in NAND, but which is not currently executing.
memory that is used in “burst” fashion; that is, it is not strictly idle, but is accessed for only relatively short periods and is idle for much longer periods, and where a small latency on access is acceptable.

On some computing devices (most notably those that implement demand paging) the identification of least-recently-used memory blocks is something that is carried out routinely and would, therefore, require no additional processing overhead. However, it should be noted that the precise method used to identify this category of inactive memory is not a part of this invention, which is concerned with how to make use of this information to minimise memory power consumption and thereby conserve power.

One method by which this might be achieved is as follows:

A list of candidate inactive memory regions (where a region is a contiguous range of logical memory blocks) is maintained. These will be regions that have not been used for a relatively extended period of time. One way of deriving this list is for the computing device to maintain a most recently used (MRU) list, where a memory region that is “in use” is moved to the top of the list. In this way, the memory blocks become ranked in frequency of use and thus, the memory regions within the bottom section of the list are prime candidates for inclusion on the list of inactive memory regions.

Determining whether a region is “in use” may be carried out in a number of ways. One method is to move all memory regions associated with a process to the top of the list when that process is scheduled to run.

In cases where an application client is able to inform the memory identification process that a memory region it owns is idle (for example, the application is going into the background, or a phone call has ended), that region is added to the list of candidate memory regions, and possibly is placed to the bottom of the list as a “prime candidate” for selection as standby mode operation.

Once the list of inactive memory regions has been determined, it becomes possible to assemble the contents of all the memory blocks it references into one or more physical memory banks by means of copying their individual contents to the new bank.

Typically, modern computing devices include an MMU which is responsible for mapping logical memory addresses to physical memory locations; in the preferred implementation of this invention, the computing device includes an MMU which ensures that any copying of memory blocks from one physical location to another is accompanied by a remapping of the logical addresses of such blocks to their new physical locations. It should be noted that such techniques are familiar to those skilled in the art of memory management.

A preferred strategy for the collection of inactive blocks and their subsequent use is as follows:
Two specific memory banks are identified from amongst those which contain a mixture of inactive and non-inactive blocks, the first being the bank with the most number of inactive blocks and the second being the bank with the least number of inactive blocks.
The contents of the non-inactive blocks from the first mixed bank are swapped with the contents of the inactive blocks from the second mixed bank, until one of the banks is no longer mixed, at which point the process is iterated from the previous step.
The iteration above continues until there is only one mixed bank remains.
At this point, the total number of unused blocks in the banks containing non-inactive blocks is calculated, and if it is possible to remove the non-inactive blocks from the remaining mixed bank by copying them into the unused blocks, this process step is carried out.
The banks containing only inactive data are then placed in low-power mode; note that this can actually be carried out contemporaneously with the iterative steps above, whenever a bank has become entirely populated by inactive blocks.
Whenever a bank containing only inactive data is placed in low power made, the MMU sets permissions on that bank such that a processor exception is generated if any attempt is made to access it.
In subsequent use, once the exception referred to above has been generated, the exception handler performs the following steps:
   it switches the memory bank that needs to be accessed into its normal active operational mode;
   it alters the permissions on the bank so that future accesses will not generate an exception;
   it then retries the instruction to access the memory.
   On this second attempt, the bank will no longer be in standby self-refresh mode, and it can therefore be read as normal.
It should be noted that when the whole computing device is subsequently placed in standby or low-power mode, on emerging from that state it will be necessary to check which banks have permissions set as above, to generate exceptions on access; such banks should be kept in low power mode even though the rest of the device is to be run under full power.

Whilst it is true that the above process itself consumes power (notably by the data copying that is required) the fact that it is inactive data that is being collated guarantees that copying memory blocks will actually be the exception rather than the rule. The consequential benefit of this invention is, therefore, that it improves the energy efficiency of the entire device.

Those skilled in the art will note that this process is somewhat analogous to the defragmentation of active memory, which enables unused blocks to be switched off, as disclosed in GB2406668 referred to above. In common with that invention, the method of the present invention may advantageously be run in the null thread, which is the thread than executes when no other threads of execution are ready to run. Alternatively, this invention can be run as a background task on the device.

The preferred implementation of this invention is on a computing device that incorporates an MMU. However, in the absence of an MMU (or if the MMU is unable to perform any of the steps in the process described above) the CPU can undertake all the tasks which have been identified as requiring an MMU in the description above.

In a further embodiment of this invention, which can be implemented when a bank is taken out of low-power mode, the computing device considers moving the memory region that needs to be accessed into unused space in a currently active bank; this means that the rest of the memory in that bank can be put back into self-refresh. A suggested mechanism for achieving this can depend on how long the region remains active, driven by a timer. If the timer expires, the region is considered to be now considerably “in use” and moved. If it is only used transiently this avoids wasting power copying it into an active bank and then copying it back to a self-refresh bank, should this be required.

FIG. 4 shows, in explanatory form, an example of rearranging active and idle memory within the RAM of a computing device. In this example the RAM comprises of three banks of memory. The original physical memory (before rearrangement) is shown to the left of the figure, where it can be seen that Bank 0 and Bank 1 each contains active, idle and empty (unallocated) memory, and that Bank 2 contains mainly idle but a small portion of active memory. Because each of the banks contains a portion of memory which is active, all three banks would normally be kept in the fully powered mode, with the attendant relatively high power consumption. However, in accordance with the present invention, the sole active memory region in Bank 2 is moved to Bank 0 and replaced with an idle memory region from Bank 1, so that Bank 2 now contains only idle memory. Likewise, the two active memory regions in Bank 1 are moved to Bank 0 and replaced by two empty memory regions from Bank 0. Therefore, all active memory regions are now collected in Bank 0, with Bank 1 containing only a mix of idle and empty memory regions, and Bank 2 containing only idle memory regions. The memory backs after such rearrangement are as shown to the right in FIG. 4. Thus, Banks 1 and 2 can be switched into self-refresh to save power, with Bank 0 remaining in the ‘on’ mode.

Thus, this invention is an extremely useful technique which can be used either in isolation, if there are no unused banks, or in addition to turning off unused banks. It makes use of the fact that it is extremely common for large amounts of memory on computing devices to be allocated but not to be actively used. For example, multi-user systems will often maintain applications which are open, but in the background. Also, certain types of process may be permanently present in the system and allocate large amounts of memory but spend a large proportion of their time idle—telephony on a phone, or caches, are good examples.

The invention is not restricted to data memory but can also apply to memory used to shadow code. For example on a NAND-Flash based system there may be a considerable amount of code shadowed into RAM but not actually executed. This could be either because the NAND-flash is simplistically shadowed as a single block of memory, or because processes and threads are loaded but idle. This is also applicable to systems that allow code to be installed via removable media, internet or over-the-air downloads. As an example, an intelligent handwriting recognition system may require both code RAM (for example, shadowed from NAND) plus handwriting data, a dictionary and working RAM. All of these components of the system are readily available to the device user, but the system is only actually active when the user is actually entering handwriting, which usually is only for a relatively small proportion of the total time that the device is powered on.

Assuming that the computing device already implements defragmentation algorithms for collecting memory in order to maximise the number of unused banks that can be switched off, this invention can extend and re-use such algorithms so that inactive memory is also collected together. In this case it becomes possible to switch the RAM banks into self-refresh to save even more power. Re-activating the memory when it is required incurs only the small delay of taking the bank out of self-refresh. This delay is far smaller than the time which would be required to reload the data into RAM.

The benefits of saving power for all devices, whether battery or mains powered, are that energy efficiency in itself is beneficial to the environment. Additionally, for mobile battery-operated computing devices, improved energy efficiency equates to longer battery life and increased utility for the owner.

Although the present invention has been described with reference to particular embodiments, it will be appreciated that modifications may be effected whilst remaining within the scope of the present invention as defined by the appended claims.

1. A method of managing resources in a computing device including memory capable of operating in a reduced functionality low-power mode, the method comprising
a. identifying blocks of memory which have been allocated but which are not in active use;
b. collecting the contents of the said inactive memory blocks in one or more physical memory banks identified for the collection of inactive data;
c. remapping the locations of the said inactive memory blocks to the said physical memory banks;
d. placing the said physical memory banks in a low-power mode for conserving energy; and wherein
e. subsequent access to any physical memory bank which has been placed in low-power mode causes the device to place the said physical memory bank into normal full-power operational mode.

2. A method according to claim 1 wherein the memory is SDRAM, and in which the low power mode is self-refresh.

3. A method according to claim 1 wherein the identification of those blocks of memory which are not in active use is managed via the maintenance of a most recently used list.

4. A method according to claim 1 wherein an analysis of past patterns of memory usage is used to determine whether or not a particular region of memory is regarded as inactive.

5. A method according to claim 1 wherein the collection of the contents of the said inactive memory blocks in one or more physical memory banks is carried out either by the null thread or by a background task.

6. A method according to claim 1 wherein the collection of inactive memory blocks is performed by iteratively swapping blocks between a bank having active blocks and the most inactive blocks and the bank having active blocks and the least inactive blocks.

7. A method according to claim 1 wherein
a. permissions on any physical memory banks containing inactive data in low-power mode are set so as to cause a processor exception when any of the said banks are accessed; and
b. a handler for the said processor exception switches the bank into normal operational mode and resets the permissions to stop further accesses generating an exception before the memory is re-accessed.

8. A method according to claim 1 wherein a memory management unit (MMU) is used to facilitate the identification of when particular blocks of memory are accessed.

9. A method according to claim 1 in wherein an MMU is used to remap the logical addresses of any memory blocks moved from one physical bank of memory to another.

10. A method according to claim 1 wherein an access to one or more blocks of memory in a memory bank containing inactive data in low-power mode causes the said blocks of memory to be moved into an active memory bank, with the said one or more blocks of memory in the memory bank containing inactive data being placed again in low-power mode.

11. A computing device programmed to implement a method according to claim 1.

12. An operating system for causing a computing device to operate in accordance with a method according to claim 1.
